(19) United States
(12) Patent Application Publication
(10) Pub. No.: US 2021/0153440 A1
(43) Pub. Date: May 27, 2021

(54) ELASTIC STRUCTURE AND CORRESPONDING INSTALLATION METHOD

(71) Applicant: ECOLE NATIONALE DES PONTS ET CHAUSSEES, Marne-La-Vallee Cedex 2 (FR)

(72) Inventors: Olivier BAVEREL, Saint Martin le Vinoux (FR); Adélaïde FERAILLE, Nanterre (FR); Frédéric TAYEB, Gagny (FR); Julien CRAVERO, Paris (FR); Ioulia TCHIGUIRINSKAIA, Paris (FR); Pierre-Antoine VERSINI, Bois le Roi (FR); Jean-François CARON, Viroflay (FR); Romain MESNIL, Paris (FR)

(73) Assignee: ECOLE NATIONALE DES PONTS ET CHAUSSEES, Marne-La-Vallee Cedex 2 (FR)

(21) Appl. No.: 17/048,400

(22) PCT Filed: Dec. 18, 2018
(86) PCT No.: PCT/FR2018/053379

§ 371 Date: Oct. 16, 2020

(30) Foreign Application Priority Data
Apr. 20, 2018 (FR) 18/53484

(51) Int. Cl. A01G 9/02

(52) U.S. Cl. CPC A01G 9/025; A01G 9/023

(57) ABSTRACT

A three-dimensional structure is obtained from a tubular preform, which is obtained from a net of the Chebyshev type having a flared shape maintained by hoops, spacers, or cables. A method for installing such a structure, in which method the tubular preform is brought to the installation point, then deformations are applied to the preform that allow the final desired flared shape to be achieved.

The present invention is concerned with a structure made by means of a meshing of elastic rods, and a method for setting up such a structure.

More precisely, this meshing of elastic rods is of the “elastic gridshell” type.

In scientific literature, thesis of Lina Bouhaya, published by the University Paris-Est in 2010, the abstract of which reminds the definition of a gridshell:

“The term gridshell designates a discrete shell which is obtained by elastically deforming a planar continuous bidirectional grid without shear rigidity and then rigidified by a third direction of bars. Thus defined, a gridshell has an interesting structural potential and can fulfil complex architectural requirements”.

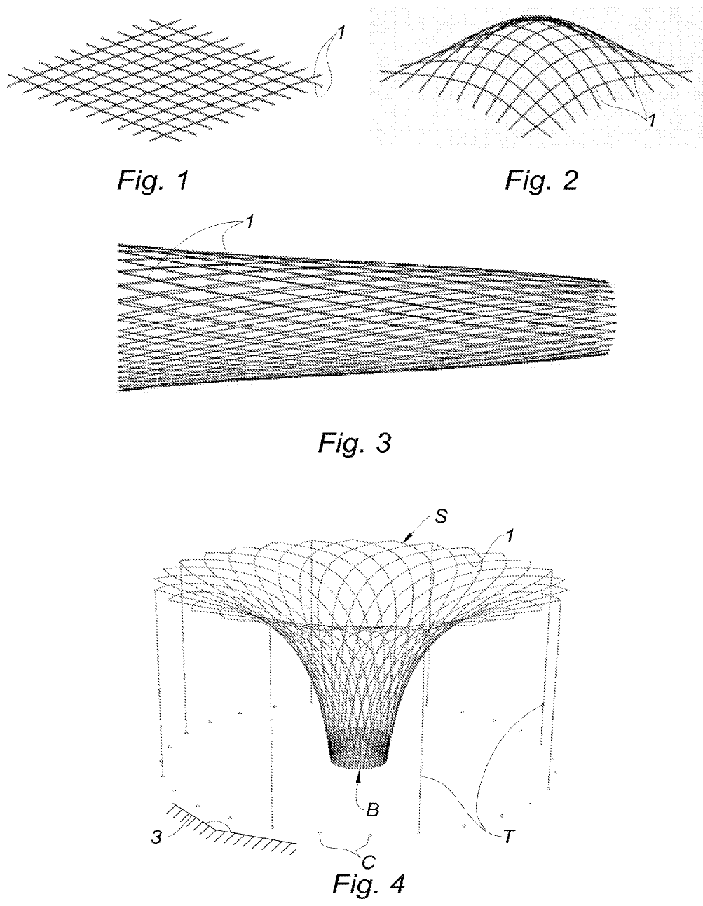

Such an elastic gridshell is obtained by means of elastically deformable rods 1, which are initially disposed according to a planar meshing, as is represented in FIG. 1.

These deformable rods are interconnected to each other by connecting means allowing variation in angles formed between these rods, without slipping and without shear strain in the meshing plane: such a planar meshing is known in scientific literature especially under the designation of Tchebychev meshing, but meshings having the abovementioned characteristics (variation in the angles between the rods without slipping and without shear strains) can be made with meshings other than Chebychev meshings.

In what follows, all these meshings will be designated as “Tchebychev type meshing”.

By acting on some points of this meshing, the planar structure represented in FIG. 1 can switch to the three-dimensional structure represented in FIG. 2.

During this deformation, angles formed between the rods vary, such that meshing squares represented in FIG. 1 become warped rhombuses (or more precisely parabolic paraboloids) in the case of the three-dimensional structure of FIG. 2 (these warped squares and rhombuses being defined by the generic term “quadrangles” in what follows).

When the three-dimensional shape of FIG. 2 is desired to be kept, the network has to be braced by attaching for example additional encirclements, spacers or cables on the rods forming the meshing, resulting in setting some of the meshing quadrangles in their deformed configuration.

When the strains applied to the rods, enabling them to be held in the configuration of FIG. 2, (non-braced grid) are removed, the structure comes back to its planar shape of FIG. 1, by virtue of the elasticity of the material forming the rods.

The material forming the deformable rods can be a composite, such as a composite with polymeric matrix having glass fibres therein, manufactured for example by pultrusion.

One purpose of the present invention is especially to make in use of these characteristics of elastic gridshells, to make an innovative structure, that can find applications in particular in the construction or street furniture field.

This purpose of the invention is achieved with a three-dimensional structure obtained from a tubular preform itself obtained from a Tchebychev type meshing, this structure having a flared shape held by means selected from the group comprising encirclements, spacers and cables: such a structure has a very attractive corolla shape, enabling in particular shaded zones to be created if it is completed by a conventional or plant cover.

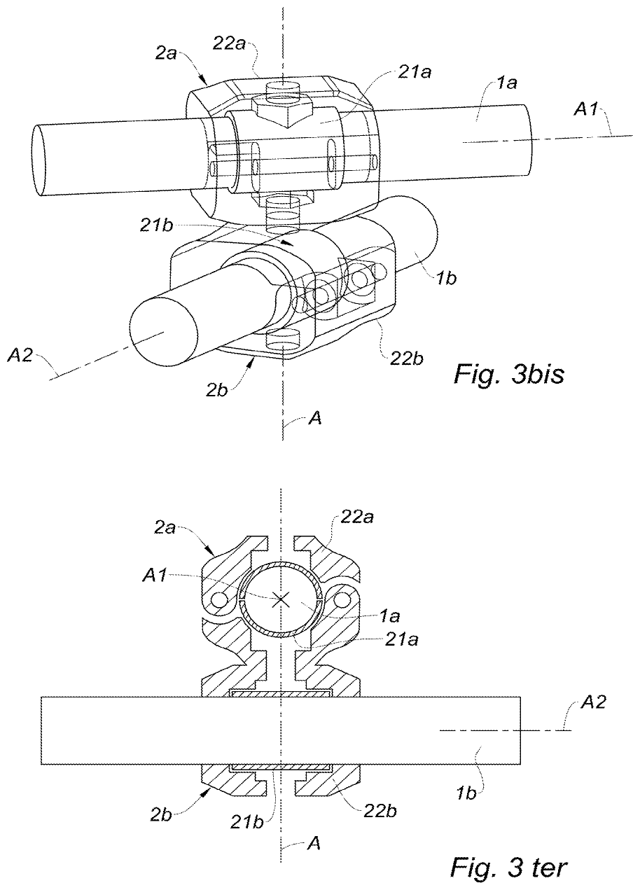

Within the scope of the present invention, the term “tubular” not only designates a simple tubular shape as represented in appended FIG. 3, but also more generally any meshing topology closed on itself, thus defining a closed volume.

The present invention also relates to a group of structures in accordance with what precedes, these structures being interconnected to each other in their larger-span zones: such a group of structures enables the surface area of the shaded zone to be increased.

The present invention also relates to an assembly comprising a structure or group of structures in accordance with what precedes, each having a shape flaring from its base to its upper part, and a block in which said base is anchored, the weight of this block can be sufficient to ensure on its own stability of said structure with respect to the ground, or aided by any additional light anchoring type: this arrangement enables the structure(s) to be very simply held in a vertical position, with a minimum coverage.

According to optional characteristics of this assembly:
said block is a container containing soil, and said structure or structures is (are) covered with plants taking root in this container: this arrangement enables a structure according to the invention to be vegetated, which is both attractive and shade generating: such a vegetalisation enables many eco-system services to be provided, such as:
   production services (production of raw materials, urban agriculture and water retention),
   regulation services (regulation of air quality, local weather, global weather by creating cooling and cool islands),
   cultural services (aesthetics, biodiversity education).
said container comprises a water storage tank, and sensors allowing connected maintenance. A solar pump can complete the device.
said structure or said structures can be covered at least partially with plates chosen from the group comprising photovoltaic panels and shade clothes: this option enables a structure according to the invention to be used as a power generating island, and/or shade element.

The present invention also relates to a device for interconnecting to each other rods of a structure in accordance with what precedes which allows free rotation of each rod about its axis, inside the device (to avoid torsion strains) and which allows any free angle between the rods (deformation of the quadrangles). Such a device can thus comprise two yokes each comprising a ring for being adhered to a rod, and a body rotatably mounted about this ring, both yokes being additionally pivotably mounted with respect to each other about an axis, intersecting the respective axes of the rings.

The present invention also relates to a method for setting up a structure in accordance with what precedes, in which said tubular preform is brought to the implementation place, and then deformations enabling the desired final flared shape to be reached are applied to this preform.

This method enables the tubular preform to be prepared in a factory, and then the structure to be very quickly installed on the chosen site.

According to optional characteristics of this method:
the upper part of said preform is connected to the ground by tie-rods so as to maintain the flared shape of the structure upon setting up said encirclements and/or spacers/cables: these tie-rods enable the structure to be given the desired form waiting for the encirclements and/or spacers/cables to be set up;
said tubular preform is pressed on the ground such that its flared part is laid on the ground, and then said encirclements and/or spacers and/or cables are set up, and then the structure is flipped such that its flared part is upwardly located: this alternative enables the structure to be simply provided with the desired shape;
the base of said structure is anchored inside a sufficient block to ensure on its own stability of the structure with respect to the ground, and this is possibly completed by a light ground anchorage: this anchorage enables maintaining the structure in a vertical position to be very simply ensured.

Further characteristics and advantages of the present invention will appear upon reading the description that follows, and upon examining the appended figures, in which:

FIGS. 1 and 2 represent a gridshell element, whose principle of deformation from the configuration of FIG. 1 to the configuration of FIG. 2 has been explained in the preamble above,

FIG. 3 represents a tubular elastic gridshell preform, enabling the structure according to the invention illustrated in the following figures to be obtained,

FIGS. 3bis and 3ter illustrate one embodiment of a means for connecting gridshell rods,

FIG. 4 represents in a perspective view, the structure according to the invention in an intermediate setting up step, by means of tie-rods connected to the ground,

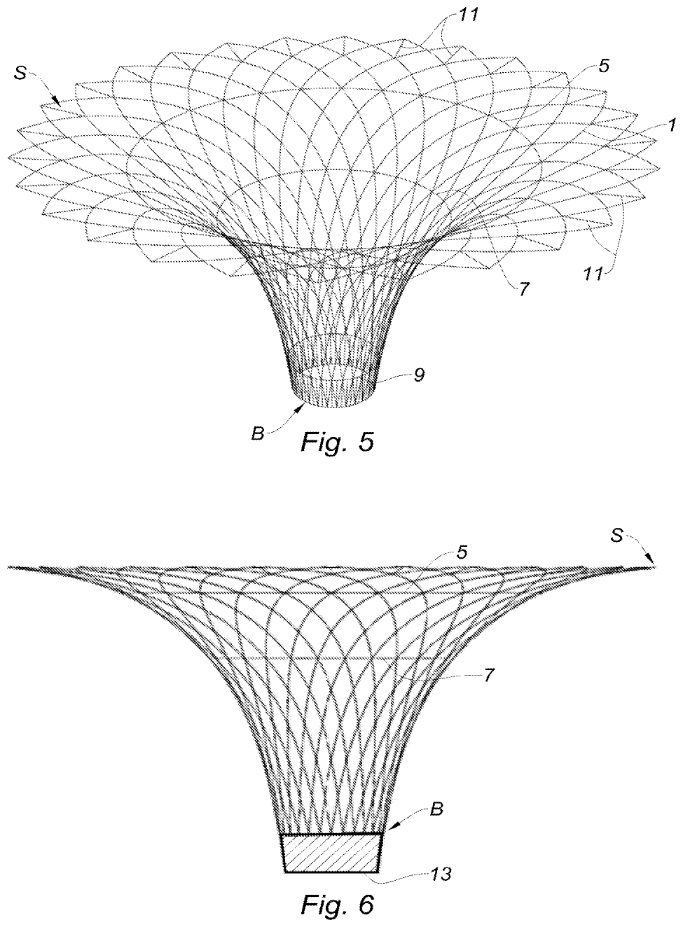

FIG. 5 represents, in a perspective view, the structure according to the invention in its final shape,

FIG. 6 illustrates this structure as an elevation view, held by a central pedestal,

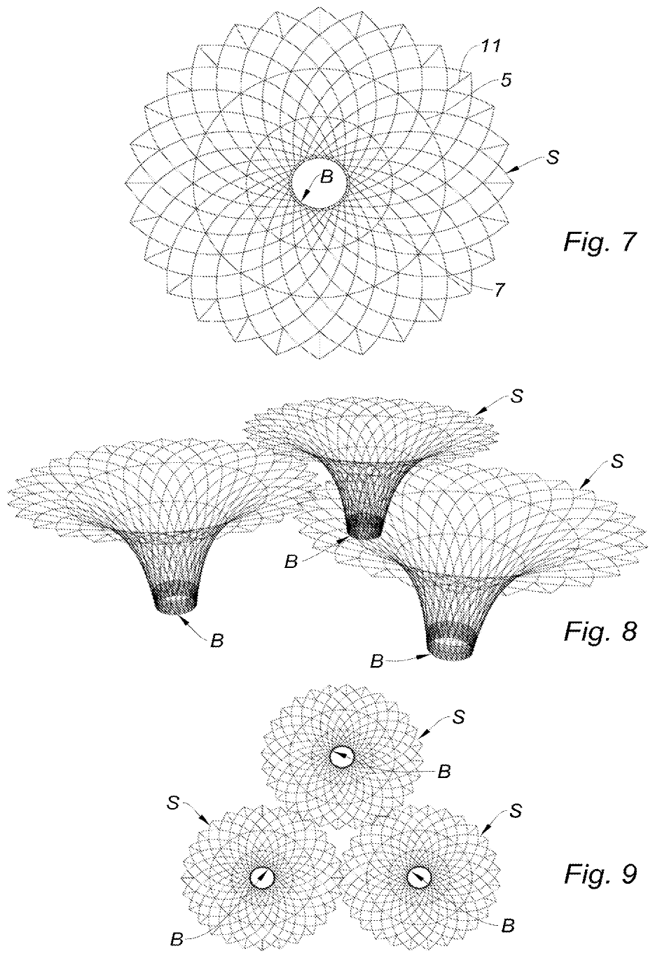

FIG. 7 illustrates this structure in a top view,

FIG. 8 represents a combination of three structures according to FIGS. 5 to 7, coupled to each other so as to make an assembly with larger dimensions,

FIG. 9 is a top view of the assembly of FIG. 8, and

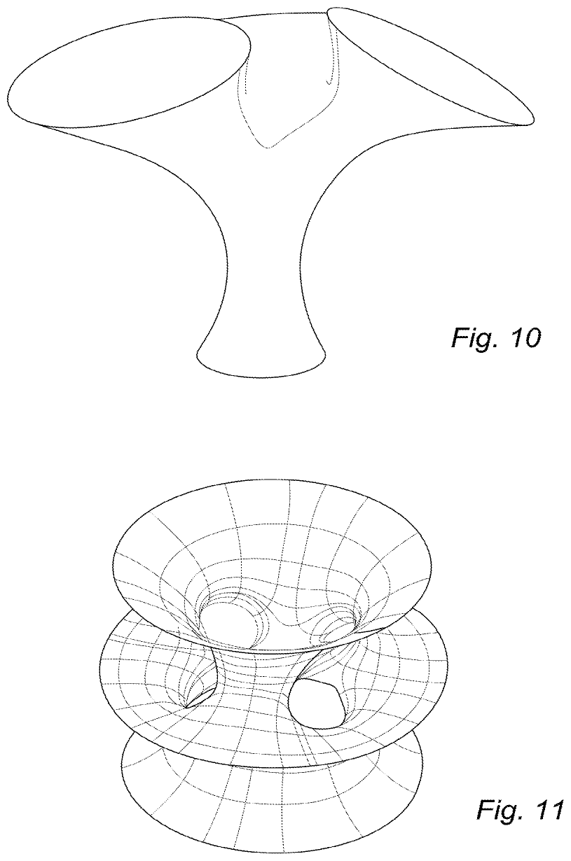

FIGS. 10 and 11 are views of other possible embodiments of structures according to the invention.

FIG. 3 is now referred to, in which an elastic gridshell preform, having a substantially cylindrical or conical tubular shape, has been represented.

This preform is made from elastically deformable rods, interconnected to each other so as to initially make a Tchebychev type planar meshing, as has been set out above.

In FIGS. 3bis and 3ter, a possible embodiment of the means for connecting the meshing rods 1 has been represented, allowing angle variation without slipping between these rods 1.

As is visible in these figures, each of the rods 1a, 1b is clamped by a respective yoke 2a, 2b, each of these yokes comprising a ring 21a, 21b adhered to the rod 1a, 1b, and a body 22a, 22b rotatably mounted about this ring 21a, 21b.

Both yokes 2a, 2b, are additionally pivotably mounted with respect to each other about an axis A, intersecting the respective axes A1 and A2 of the rings 21a and 21b.

From this tubular preform, the meshing is deformed so as to obtain the corolla shape represented in FIG. 4.

This shape, which is flaring from the base B, to the upper part S of the structure, is obtained by means of a plurality of tie-rods T interconnecting the edge of the upper part S to the ground 3.

These tie-rods can comprise for example metal cables, attached to the ground 3 by hooks C.

Once the desired corolla shape represented in FIG. 4 has been provided to the meshing, this shape is set by setting up encirclements 5, 7, 9 attached to the rods 1 of the structure without slipping possibilities.

In other words, these encirclements enable the quadrangles formed by the adjacent rods to be made non-deformable by defining two non-deformable triangles in each of these quadrangles.

In this way, an elastic gridshell as defined above is obtained.

Alternatively or complementarily, spacers or cables 11 can also be attached within some quadrangles, also making these quadrangles non-deformable: in the example represented in FIG. 5, these spacers 11 are disposed in the quadrangles defining the edge of the upper part S of the structure according to the invention.

Once these encirclements 5, 7, 9 and/or these spacers 11 have been attached to the structure according to the invention, this structure can keep its corolla shape represented in FIG. 5, without requiring to connect it to an external support.

It will be noted that another possible way of proceeding, enabling setting up tie-rods T to be dispensed with, is to assemble the structure according to the invention upside down, that is such that its flared part S is laid on the ground; once the encirclements 5, 7, 9 and spacers 11 are set up, the structure is then flipped so as to brought it to its final position, as represented in FIG. 6, that is with the flared part S upwardly located.

When it is desired to maintain this structure in place on the ground, it is sufficient to attach its base B inside a ponderous pedestal 13, as is represented in FIG. 6, this pedestal can be a concrete block, or a container receiving soil, for example.

Thus, under the effect of the weight of the pedestal 13 only, the structure according to the invention can keep its vertical position, with the pedestal 13 laid on the ground, and the upper part S of this structure being located above, and vertical to this pedestal.

Advantageously, when the pedestal 13 is a container receiving soil and water, the elastic gridshell on top of it can make it possible to grow climbing plants (vine, trumpet vine, hops, honeysuckle, clematis, passion flower for example) taking root in the soil of this container and quickly spreading on the entire gridshell.

The choice of species as well as the arrangement thereof is made as a function of weather, orientation of the structure and maintenance measures that will have to be foreseen.

The plants are planted young enough to be able to adapt to their environment and grow in optimal conditions.

An extended vegetated cover taking root in a reduced, readily accessible volume (easy maintenance) is obtained.

It is also possible to attach vegetated containers (annual plants) high up to the structure.

A vegetated structure, which is particularly attractive for urban planning in environments with a high mineral content due to the densification and the resulting high level of soil sealing, is obtained.

This new urban element thus takes part in the highly approved town renaturation in recent years.

It is generally highlighted to fight against urban heat islands which represent localised temperature rises due to the absence of vegetation.

This structure can indeed be put at selected locations in the city, and make up a decorative element, likely to be deformably moved, depending on the wind.

When this structure is vegetated, or covered with a skin for example of synthetic fabric or polymeric material, it enables shade zones, in which for example benches can be disposed, to be obtained.

Vegetation thus has the advantage to cool beyond the simple decrease in the radiation balance (shading), since it enables air to be cooled by virtue of the energy consumed by the plants (roots and leaves) via the evapotranspiration process.

It will be additionally noted that the structure as described in FIGS. 4 to 9 has an iso-radial nature, that is all the quadrangles define planar surfaces, facilitating setting up for example insert elements such as photovoltaic panels: in the latter case, besides its aesthetical and shading properties, the structure according to the invention can make up a power generating island.

Advantageously, and as is represented in FIGS. 8 and 9, several structures, and in the example represented, three structures according to the invention, can be adjacently disposed, and connected to each other in their upper parts S, so as to form a larger-surface area assembly, which is particularly attractive: this can then be referred to as a corolla bench of elastic gridshells.

If vegetated, this assembly allows mixing of species (originating a larger animal biodiversity) and creating a plant continuum (green open system or stepping stones).

As can be understood in the light of the preceding description, the structure of elastic gridshell according to the invention can be implemented very simply from a tubular preform that can be easily transported to the implementation place, and does not require any particular construction on the ground, this hold being achieved only by virtue of the weight of the pedestal 13 in which it is attached. An additional anchorage is however possible to enhance stability if necessary.

Since the coverage of this pedestal 13 is very low in comparison with the span of the upper part S of the structure according to the invention, a structure is obtained, which, in spite of having a large shading ability, only takes up very little of public space likely to be walked on by the passers-by: this frees up space for example for setting up benches.

By way of purely indicating and in no way limiting purposes, a structure of elastic gridshell according to the invention can be several meters high, typically between 3 and 5 metres.

Of course, the present invention is in no way limited to the embodiments described and represented.

Thereby, any wanted undulation could be provided to the structure, by differentially deforming it: a non-axisymetric structure would then be obtained. For example, a jar with an elliptic and not cylindrical cross-section propagates an undulation of the edges of the upper corolla (as in the girolle type mushroom).

By way of example, other complex gridshell shapes falling within the inventive concept of the present invention have been represented in FIGS. 10 and 11.

In FIG. 10, a quadrinoid surface obtained from a Tchebychev type meshing assembly has for example been represented, and in FIG. 11, this is a Costa surface: these multiple-corolla shapes can be obtained from a more complex tubular closed preform than that represented in FIG. 3.

1. A three-dimensional structure obtained from a tubular preform itself obtained from a Tchebychev type meshing, this structure having a flared shape held by means selected from the group comprising encirclements, spacers, and cables.

2. A group of structures according to claim 1, these structures being connected to each other in their larger-span zones.

3. An assembly comprising a structure in accordance with claim 1, each having a shape flaring from its base to its upper part, and a block in which said base is anchored, the weight of this block being sufficient to ensure on its own stability of said structure with respect to the ground.

4. The assembly according to claim 3, wherein said block is a container containing soil, and said structure is covered with plants taking root in this container.

5. The assembly according to claim 4, wherein said container comprises elements chosen from the group comprising a water storage, sensors allowing a connected maintenance, a solar pump.

6. The assembly according to claim 3, wherein said structure is covered at least partially with plates chosen from the group comprising photovoltaic panels and shade cloths.

7. A device for interconnecting rods forming a structure in accordance with claim 1, comprising two yokes each comprising a ring for being adhered to a rod, and a body rotatably mounted about this ring, both yokes being additionally pivotably mounted with respect to each other about an axis, intersecting the respective axes of the rings.

8. A method for setting up a structure in accordance with claim 1, in which said tubular preform is brought to the implementation place, and then deformations for achieving the desired final flared shape are applied to this preform, and in which:
the upper part is interconnected to said preform on the ground by tie-rods so as to maintain the flared shape of the structure upon setting up said encirclements and/or spacers and/or,
said tubular preform is pressed on the ground such that its flared part is laid on the ground, and then said encirclements and/or spacers and/or cables are set up, and then the structure is flipped such that its flared part is located upwardly.

9. The method according to claim 8, wherein the base of said structure is anchored inside a block sufficient to ensure on its own stability of the structure with respect to the ground, and that can be completed by a light ground anchorage for particular conditions of use.
